(19) United States
(12) Patent Application Publication
(10) Pub. No.: US 2025/0323955 A1
(43) Pub. Date: Oct. 16, 2025

(54) SYSTEMS AND METHODS FOR CREATING INTERNET PROTOCOL MULTIMEDIA SUBSYSTEM DATA CHANNELS FOR USAGE BY APPLICATIONS

(71) Applicant: Verizon Patent and Licensing Inc., Basking Ridge, NJ (US)

(72) Inventors: Lalit R. KOTECHA, San Ramon, CA (US); Violeta CAKULEV, Milburn, NJ (US); Shanthala KURAVANGI-THAMMAIAH, Keller, TX (US); Lixia YAN, Basking Ridge, NJ (US)

(73) Assignee: Verizon Patent and Licensing Inc., Basking Ridge, NJ (US)

(21) Appl. No.: 18/632,842

(22) Filed: Apr. 11, 2024

(51) Int. Cl. H04L 65/1016; H04L 65/1066

(52) U.S. Cl. CPC H04L 65/1016; H04L 65/1066

(57) ABSTRACT

In some implementations, a device may receive a request to create an Internet Protocol multimedia subsystem (IMS) data channel for usage by an application that executes on a user equipment (UE). The device may transmit, based on the request, an inquiry as to whether the IMS data channel already exists for the UE. The device may receive a response that indicates that the IMS data channel does not already exist for the UE. The device may forward, based on the response, the request to create the IMS data channel. The device may receive an indication that the IMS data channel has been successfully created. The device may forward the indication that the IMS data channel has been successfully created.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example associated with creating Internet Protocol multimedia subsystem (IMS) data channels for usage by applications.

FIG. 2 is a diagram of an example environment in which systems and/or methods described herein may be implemented.

FIG. 3 is a diagram of example components of one or more devices of FIG. 2.

FIG. 4 is a flowchart of an example process associated with creating IMS data channels for usage by applications.

### DETAILED DESCRIPTION OF EXAMPLE EMBODIMENTS

The following detailed description of example implementations refers to the accompanying drawings. The same reference numbers in different drawings may identify the same or similar elements.

An IMS data channel may be defined in accordance with an Internet Engineering Task Force (IETF) standard and/or a Third Generation Partnership Project (3GPP) standard. The IMS data channel may allow content to be carried during communication between two user equipments (UEs), where the content may be beyond voice data, video data, and/or messaging data. The IMS data channel may allow for enriched calling features, such as in-call content sharing and/or in-call advertising. The IMS data channel may allow users to share applications during voice calls. For example, the IMS data channel may allow users to share visual interfaces and documents, as well as shared gaming and screen sharing.

The IMS data channel may not provide a framework for a communication service provider. The IMS data channel may not provide a mechanism for authentication of an application, authorization of the application, and/or policy enforcement. As a result, applications may be ineffective in using the IMS data channel and/or may be unable to utilize the IMS data channel. For example, applications that attempt to use the IMS data channel may not be subject to authentication, authorization, and/or policy control. Applications with certain requirements in terms of authorization, authentication, and/or policy control may be unable to utilize the IMS data channel. An overall performance of the IMS data channel may be degraded without the framework being defined for the communication service provider.

In some implementations, an application executing on a UE may send a request to an application server, where the request may indicate an intention of the application to use an IMS data channel. The request may include desired traffic characteristics, such as a bit rate, a quality of service (QOS), and so on. The request may be performed over an Internet access point name (APN). The application server may request an IMS exposure function to create the IMS data channel and allow the application to use the IMS data channel. The IMS exposure function may be introduced with a key gating factor for any application to use IMS data channel services, and the IMS exposure function may provide application authentication, authorization, and/or policy enforcement. The IMS exposure function may be used to create an application ecosystem associated with usage of IMS data channels. The IMS exposure function may check with an authentication server for authorization of the application (e.g., a 5G subscriber data management (SDM)). In other words, a user application authentication to use the IMS data channel may be via the SDM. The IMS exposure function may check with an IMS data channel server as to whether the IMS data channel already exists for that particular UE, and when the IMS data channel does not already exist, the IMS exposure function may request the IMS data channel server to create the IMS data channel. After a successful creation of the IMS data channel, the IMS exposure function may request a policy server to install a policy on the IMS data channel server. In other words, a policy installation on the IMS data channel server may be per application based, and may be programmed into a policy control function (PCF). The policy may define data rates, priority, etc. for the application. After a successful policy install, the IMS exposure function may return a success to the application server, at which point the application and the application server may be able to communicate with each other using the IMS data channel of the requested characteristics. Alternatively, after the IMS data channel is created, the application may directly communicate with another application executing on another UE, via a peer-to-peer (P2P) communication, where an authentication is via the application server. Further, the IMS exposure function may interact with a billing and charging function for per-application usage reporting of the IMS data channel.

In some implementations, a framework may be defined for a communication service provider. The framework may enable a usage of the IMS data channel. The framework may define the IMS exposure function (e.g., an IMS gateway), along with authentication and authorization of the application to use the IMS data channel. The framework may also provide a policy control, which may define a manner in which each application is policy enforced to use the IMS data channel.

In some implementations, by creating the framework that enables the usage of the IMS data channel, certain applications may be authorized to use the IMS data channel. Such applications may be properly authorized and/or authenticated prior to an approval to use the IMS data channel. The applications may be subject to policy control, which may be application specific and enforced by an IMS data channel server. The policy control may align with requested traffic characteristics prior to creating the IMS data channel. As a result, a communication service provider may use the framework to provide applications with enhanced data (e.g., data beyond voice, video, and messaging), thereby improving an overall system performance.

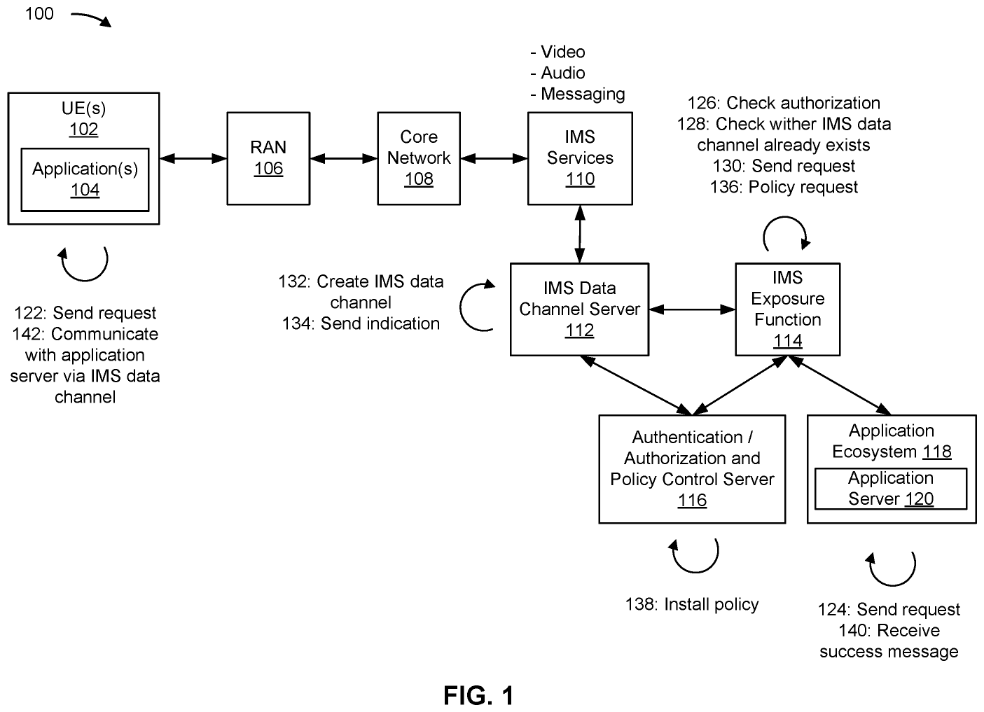

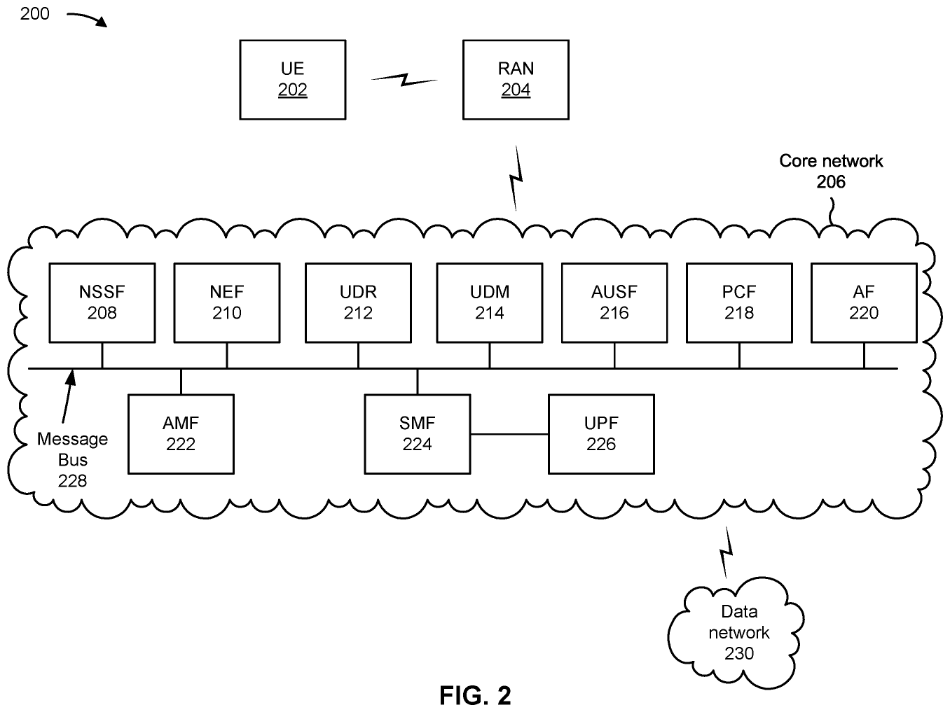

FIG. 1 is a diagram of an example 100 associated with creating IMS data channels for usage by applications. As shown in FIG. 1, example 100 includes a UE 102 (or multiple UEs) that executes an application 104, a RAN 106, a core network 108, IMS services 110, an IMS data channel server 112, an IMS exposure function 114, an authentication/authorization and policy control server 116, and application ecosystem 118. The application ecosystem 118 may be associated with an application server 120. The UE 102, the RAN 106, and the core network 108 may correspond to UE 202, RAN 204, and core network 206, as shown in FIG. 2.

As shown by reference number 122, the application 104 may send, to the application server 120, a request to create an IMS data channel for usage by the application 104. The application 104 may request that the IMS data channel be created so that the application 104 may be able to use the IMS data channel. The request to create the IMS data channel may include one or more requested characteristics to be associated with the IMS data channel. The one or more characteristics may be associated with a bit rate, a jitter, a latency, and/or a QoS. The IMS data channel may support additional content beyond voice, video, and messaging, where the additional content may be associated with in-call content sharing, in-call advertising, application sharing, document sharing, game sharing, and/or screen sharing. The application 104 may send the request to the application server 120 via an Internet APN.

As shown by reference number 124, the application server 120 may receive the request to create the IMS data channel from the application 104, and the application server 120 may forward the request to create the IMS data channel to the IMS exposure function 114. The application server 120 may request that the IMS exposure function 114 create the IMS data channel and allow the application 104 to use the IMS data channel.

As shown by reference number 126, the IMS exposure function 114 may receive the request to create the IMS data channel from the application server 120, and the IMS exposure function 114 may transmit signaling to confirm that the application is authorized to use the IMS data channel. The IMS exposure function 114 may check with the authentication/authorization and policy control server 116 as to whether the application is authorized to use the IMS data channel. The IMS exposure function 114 may receive, from the authentication/authorization and policy control server 116, that the application is authorized to use the IMS data channel.

As shown by reference number 128, the IMS exposure function 114 may transmit, to the IMS data channel server 112 and based on the request to create the IMS data channel, an inquiry as to whether the IMS data channel already exists for the UE. In other words, the IMS exposure function 114 may check with the IMS data channel server 112 as to whether the IMS data channel already exists for that particular UE 102. The IMS data channel server 112 may send, to the IMS exposure function 114, an indication of whether the IMS data channel already exists for the UE 102. For example, the IMS exposure function 114 may receive, from the IMS data channel server 112, a response that indicates that the IMS data channel does not already exist for the UE 120.

As shown by reference number 130, the IMS exposure function 114 may transmit, to the IMS data channel server 112, the request to create the IMS data channel. The IMS exposure function 114 may transmit the request to create the IMS data channel based on the response received from the IMS data channel server 112. For example, the IMS exposure function 114 may transmit the request to create the IMS data channel only when the response indicates that the IMS data channel does not already exist for the UE 120. The IMS exposure function 114 may not transmit the request to create the IMS data channel when the response indicates that the IMS data channel has already been created for the UE 120.

As shown by reference number 132, the IMS data channel server 112 may create the IMS data channel for usage by the application 104. The IMS data channel server 112 may create the IMS data channel to support the requested characteristics (e.g., bit rate, jitter, latency, and/or QoS). Alternatively, the IMS data channel server 112 may create the IMS data channel to support a portion of the requested characteristics. The IMS data channel server 112 may create the IMS data channel to support the additional content beyond voice, video, and messaging. As shown by reference number 134, the IMS data channel server 112 may send, to the IMS exposure function 114, an indication that the IMS data channel has been successfully created.

As shown by reference number 136, the IMS exposure function 114 may transmit, to the authentication/authorization and policy control server 116 and based on the IMS data channel being successfully created, a request to install a policy on the IMS data channel server 112 that creates the IMS data channel. The policy may define a set of parameters (e.g., data rate, priority, and so on) for the usage of the IMS data channel by the application. The policy may be specific or unique to the application. In other words, different applications may be associated with different policies, where each policy may define a set of parameters that are specific to a particular application. As shown by reference number 138, the authentication/authorization and policy control server 116 may install the policy with the IMS data channel server 112. The authentication/authorization and policy control server 116 may indicate, to the IMS exposure function 114, that the policy has been created and applied for the IMS data channel.

As shown by reference number 140, the IMS exposure function 114 may send, to the application server 120, an indication that the IMS data channel has been successfully created. In other words, after a successful policy installation, the IMS exposure function 114 may return a success message to the application server 120. As shown by reference number 142, after the IMS data channel has been successfully created, the application server 120 may be able to communicate with the application 104 via the IMS data channel, where the IMS data channel may be associated with the requested characteristics (or a portion of the requested characteristics). The IMS data channel may facilitate communications between the application 104 and an application server 120.

In some implementations, the UEs 102 may include a first UE and a second UE, and the applications 104 may include a first application and a second application, where the first UE executes the first application and the second UE executes the second application. In this case, the IMS data channel may facilitate communications between the first application and the second application (instead of between the UE 102 and the application server 120). In this case, the IMS data channel may support a P2P communication between the two UEs.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example environment 200 in which systems and/or methods described herein may be implemented. As shown in FIG. 2, example environment 200 may include a UE 202, a RAN 204, a core network 206, and a data network 230. Devices and/or networks of example environment 200 may interconnect via wired connections, wireless connections, or a combination of wired and wireless connections.

The UE 202 may include one or more devices capable of receiving, generating, storing, processing, and/or providing information, such as information described herein. For example, the UE 202 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 204 may support, for example, a cellular radio access technology (RAT). The RAN 204 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 202. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 204 may transfer traffic between the UE 202 (e.g., using a cellular RAT), one or more base stations (e.g., using a wireless interface or a backhaul interface, such as a wired backhaul interface), and/or the core network 206. The RAN 204 may provide one or more cells that cover geographic areas.

In some implementations, the RAN 204 may perform scheduling and/or resource management for the UE 202 covered by the RAN 204 (e.g., the UE 202 covered by a cell provided by the RAN 204). In some implementations, the RAN 204 may be controlled or coordinated by a network controller, which may perform load balancing, network-level configuration, and/or other operations. The network controller may communicate with the RAN 204 via a wireless or wireline backhaul. In some implementations, the RAN 204 may include a network controller, a self-organizing network (SON) module or component, or a similar module or component. In other words, the RAN 204 may perform network control, scheduling, and/or network management functions (e.g., for uplink, downlink, and/or sidelink communications of the UE 202 covered by the RAN 204).

In some implementations, the core network 206 may include an example functional architecture in which systems and/or methods described herein may be implemented. For example, the core network 206 may include an example architecture of a 5G next generation (NG) core network included in a 5G wireless telecommunications system. While the example architecture of the core network 206 shown in FIG. 2 may be an example of a service-based architecture, in some implementations, the core network 206 may be implemented as a reference-point architecture and/or a 2G core network, among other examples.

As shown in FIG. 2, the core network 206 may include a number of functional elements. The functional elements may include, for example, a network slice selection function (NSSF) 208, a network exposure function (NEF) 210, a unified data repository (UDR) 212, a unified data management (UDM) 214, an authentication server function (AUSF) 216, a PCF 218, an application function (AF) 220, an access and mobility management function (AMF) 222, a session management function (SMF) 224, and/or a user plane function (UPF) 226. These functional elements may be communicatively connected via a message bus 228. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 208 may include one or more devices that select network slice instances for the UE 202. The NSSF 208 may allow an operator to deploy multiple substantially independent end-to-end networks potentially with the same infrastructure. In some implementations, each slice may be customized for different services. The NEF 210 may include one or more devices that support exposure of capabilities and/or events in the wireless telecommunications system to help other entities in the wireless telecommunications system discover network services.

The UDR 212 may include one or more devices that provide a converged repository, which may be used by network functions to store data. For example, a converged repository of subscriber information may be used to service a number of network functions. The UDM 214 may include one or more devices to store user data and profiles in the wireless telecommunications system. The UDM 214 may generate authentication vectors, perform user identification handling, perform subscription management, and perform other various functions. The AUSF 216 may include one or more devices that act as an authentication server and support the process of authenticating the UE 202 in the wireless telecommunications system.

The PCF 218 may include one or more devices that provide a policy framework that incorporates network slicing, roaming, packet processing, and/or mobility management, among other examples. The AF 220 may include one or more devices that support application influence on traffic routing, access to the NEF 210, and/or policy control, among other examples. The AMF 222 may include one or more devices that act as a termination point for non-access stratum (NAS) signaling and/or mobility management, among other examples. The SMF 224 may include one or more devices that support the establishment, modification, and release of communication sessions in the wireless telecommunications system. For example, the SMF 224 may configure traffic steering policies at the UPF 226 and/or may enforce UE internet protocol (IP) address allocation and policies, among other examples. The UPF 226 may include one or more devices that serve as an anchor point for intra-RAT and/or inter-RAT mobility. The UPF 226 may apply rules to packets, such as rules pertaining to packet routing, traffic reporting, and/or handling user plane QoS, among other examples. The message bus 228 may represent a communication structure for communication among the functional elements. In other words, the message bus 228 may permit communication between two or more functional elements.

The data network 230 may include one or more wired and/or wireless data networks. For example, the data network 230 may include an Internet Protocol multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of example environment 200 may perform one or more functions described as being performed by another set of devices of example environment 200.

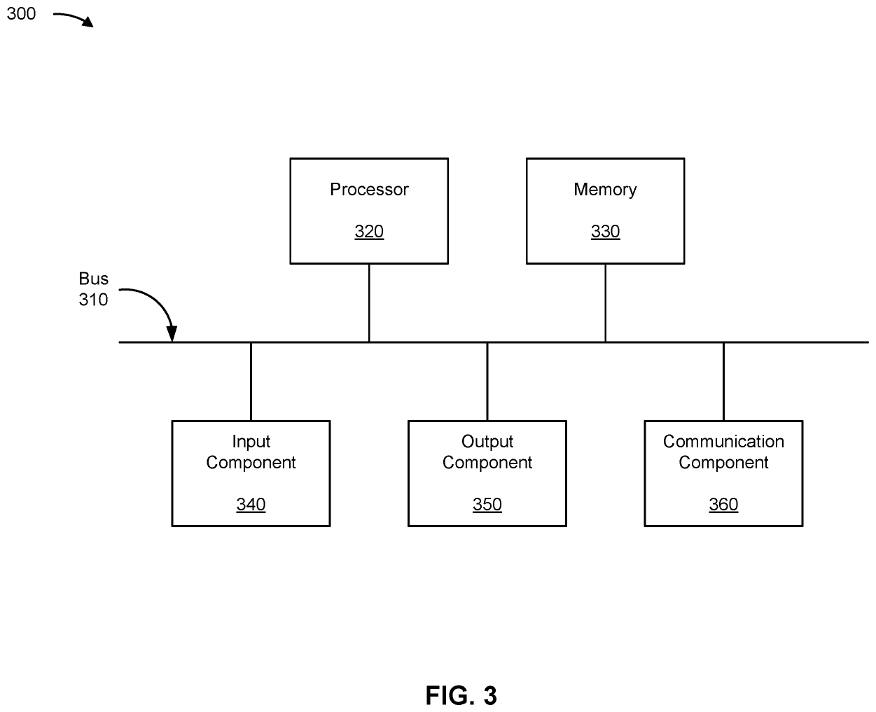

FIG. 3 is a diagram of example components of a device 300 associated with creating IMS data channels for usage by applications. The device 300 may correspond to an IMS exposure function (e.g., IMS exposure function 114). In some implementations, the network device may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

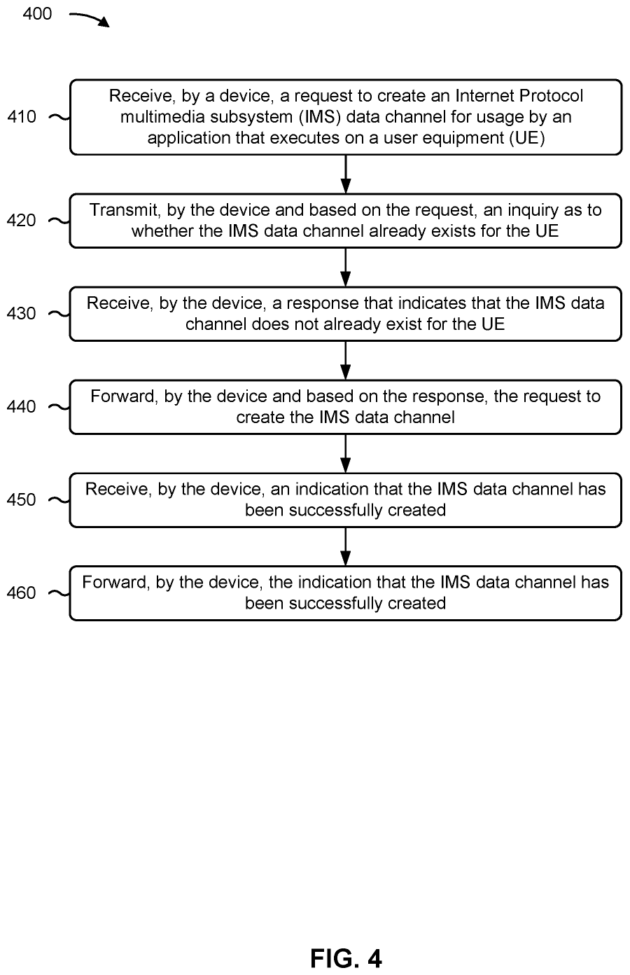

FIG. 4 is a flowchart of an example process 400 associated with creating IMS data channels for usage by applications. In some implementations, one or more process blocks of FIG. 4 may be performed by a device (e.g., IMS exposure function 114). In some implementations, one or more process blocks of FIG. 4 may be performed by another entity or a group of entities separate from or including the IMS exposure function. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, by the device, a request to create an IMS data channel for usage by an application that executes on a UE (block 410). The request to create the IMS data channel may include one or more requested characteristics. The one or more requested characteristics may be associated with a bit rate, a jitter, a latency, and/or a QoS. The request may be received from an application server. The application server may transmit the request based on a request received from the application.

As shown in FIG. 4, process 400 may include transmitting, by the device and based on the request, an inquiry as to whether the IMS data channel already exists for the UE (block 420). An IMS data channel server may receive the inquiry and check whether the IMS data channel already exists for the UE.

As shown in FIG. 4, process 400 may include receiving, by the device, a response that indicates that the IMS data channel does not already exist for the UE (block 430). The IMS data channel server may transmit the response indicating that the IMS data channel does not already exist for the UE.

As shown in FIG. 4, process 400 may include forwarding, by the device and based on the response, the request to create the IMS data channel (block 440). The request to create the IMS data channel may not be forwarded when the IMS data channel already exists for the UE.

As shown in FIG. 4, process 400 may include receiving, by the device, an indication that the IMS data channel has been successfully created (block 450). The request may be received from the IMS data channel server, which may be responsible for creating the IMS data channel.

As shown in FIG. 4, process 400 may include forwarding, by the device, the indication that the IMS data channel has been successfully created (block 460). The indication may be forwarded to the application server. The IMS data channel may enable communications between the application server and the application.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to create an Internet Protocol multimedia subsystem (IMS) data channel for usage by an application that executes on a user equipment (UE);
transmitting, by the device and based on the request, an inquiry as to whether the IMS data channel already exists for the UE;
receiving, by the device, a response that indicates that the IMS data channel does not already exist for the UE;
forwarding, by the device and based on the response, the request to create the IMS data channel;
receiving, by the device, an indication that the IMS data channel has been successfully created; and
forwarding, by the device, the indication that the IMS data channel has been successfully created.

2. The method of claim 1, wherein the request to create the IMS data channel includes one or more requested characteristics, wherein the one or more requested characteristics are associated with one or more of: a bit rate, a jitter, a latency, or a quality of service (QOS).

3. The method of claim 1, further comprising:
transmitting, by the device and in response to the request to create the IMS data channel, signaling to confirm that the application is authorized to use the IMS data channel.

4. The method of claim 1, further comprising:
transmitting, by the device and based on the IMS data channel being successfully created, a request to install a policy on an IMS data channel server that creates the IMS data channel, wherein the policy defines a set of parameters for the usage of the IMS data channel by the application, and the policy is specific to the application.

5. The method of claim 1, wherein the IMS data channel facilitates communications between the application and an application server.

6. The method of claim 1, wherein the application is a first application and the UE is a first UE, and the IMS data channel facilitates communications between the first application and a second application that executes on a second UE.

7. The method of claim 1, further comprising:
transmitting, by the device, per-application usage reporting of the IMS data channel to a billing and charging function.

8. The method of claim 1, further comprising:
controlling, by the device, applications that are able to access IMS data channel services based on one or more of: an application authentication, an application authorization, or a policy enforcement.

9. A device, comprising:
one or more processors configured to:
receive a request to create an Internet Protocol multimedia subsystem (IMS) data channel;
transmit, based on the request, an inquiry as to whether the IMS data channel already exists for a user equipment (UE);
receive a response that indicates that the IMS data channel does not already exist for the UE;
forward, based on the response, the request to create the IMS data channel;
receive an indication that the IMS data channel has been successfully created; and
forward the indication that the IMS data channel has been successfully created.

10. The device of claim 9, wherein the request to create the IMS data channel includes one or more requested characteristics, wherein the one or more requested characteristics are associated with one or more of: a bit rate, a jitter, a latency, or a quality of service (QOS).

11. The device of claim 9, wherein the one or more processors are further configured to:
transmit, in response to the request to create the IMS data channel, signaling to confirm that an application is authorized to use the IMS data channel.

12. The device of claim 9, wherein the one or more processors are further configured to:
transmit, based on the IMS data channel being successfully created, a request to install a policy on an IMS data channel server that creates the IMS data channel, wherein the policy defines a set of parameters for the usage of the IMS data channel by an application, and the policy is specific to the application.

13. The device of claim 9, wherein the IMS data channel facilitates communications between an application and an application server.

14. The device of claim 9, wherein an application is a first application and the UE is a first UE, and the IMS data channel facilitates communications between the first application and a second application that executes on a second UE.

15. The device of claim 9, wherein the one or more processors are further configured to:
transmit per-application usage reporting of the IMS data channel to a billing and charging function.

16. The device of claim 9, wherein the one or more processors are further configured to:
control applications that are able to access IMS data channel services based on one or more of: an application authentication, an application authorization, or a policy enforcement.

17. The device of claim 9, wherein the device is associated with an IMS exposure function, and the IMS exposure function is associated with an IMS data channel server.

18. A non-transitory computer-readable medium storing a set of instructions, the set of instructions comprising:
one or more instructions that, when executed by one or more processors of a device, cause the device to:
receive a request to create an Internet Protocol multimedia subsystem (IMS) data channel for usage by an application that executes on a user equipment (UE);
transmit, based on the request, an inquiry as to whether the IMS data channel already exists for the UE;
receive a response that indicates that the IMS data channel does not already exist for the UE;
forward, based on the response, the request to create the IMS data channel;
receive an indication that the IMS data channel has been successfully created; and
forward the indication that the IMS data channel has been successfully created.

19. The non-transitory computer-readable medium of claim 18, wherein the one or more instructions, when executed by the one or more processors, further cause the device to:
transmit, in response to the request to create the IMS data channel, signaling to confirm that the application is authorized to use the IMS data channel;
transmit, based on the IMS data channel being successfully created, a request to install a policy on an IMS data channel server that creates the IMS data channel, wherein the policy defines a set of parameters for the usage of the IMS data channel by the application, and the policy is specific to the application;
transmit per-application usage reporting of the IMS data channel to a billing and charging function; or
control applications that are able to access IMS data channel services based on one or more of: an application authentication, an application authorization, or a policy enforcement.

20. The non-transitory computer-readable medium of claim 18, wherein:
the request to create the IMS data channel includes one or more requested characteristics, wherein the one or more requested characteristics are associated with one or more of: a bit rate, a jitter, a latency, or a quality of service (QOS);
the IMS data channel facilitates communications between the application and an application server;
the application is a first application and the UE is a first UE, and the IMS data channel facilitates communications between the first application and a second application that executes on a second UE; or
the device is associated with an IMS exposure function, and the IMS exposure function is associated with an IMS data channel server.
